(19) United States
(12) Patent Application Publication
(10) Pub. No.: US 2022/0012075 A1
(43) Pub. Date: Jan. 13, 2022

(54) VIRTUAL ASSISTANT INTERACTION ENHANCEMENT

(71) Applicant: International Business Machines Corporation, Armonk, NY (US)

(72) Inventors: Michal Paluch, Krakow (PL); Nicolò Sgobba, Fasano (IT); Erik Rueger, Ockenheim (DE); Julien Loeve, Brno (CZ)

(21) Appl. No.: 16/923,173

(22) Filed: Jul. 8, 2020

(51) Int. Cl. G06F 9/451; G06F 3/048; G06N 3/08

(52) U.S. Cl. CPC G06F 9/453; G06N 3/08; G06F 3/048

(57) ABSTRACT

A user input is received. The user input is classified using a neural network. A set of contextual information for the user input is determined, based on the classification. The user input is modified, based on the classification and the set of contextual information. The modified user input is passed to a virtual assistant.

### BACKGROUND

The present disclosure relates generally to the field of virtual assistants, and more particularly to enhancing virtual assistant interactions.

Virtual assistants, such as ALEXA, LEX, LOUIS, CORTANA, SIRI, BIXBY, DIALOGFLOW and GOOGLE ASSISTANT provide users with the ability to input computing commands and requests using verbal or textual inputs (e.g., via spoken words/phrases and/or text).

Neural networks and machine learning are becoming more and more prevalent in several aspects of computer science. Machine learning models may be used for a wide variety of applications, such as “reading” handwritten documents, facial recognition techniques, generating and calculating algorithms, generating dynamic navigation routes that take into account historical traffic density, etc.

### SUMMARY

Embodiments of the present disclosure include a method, computer program product, and system for enhancing virtual assistant interactions.

A user input is received. The user input is classified using a neural network. A set of contextual information for the user input is determined, based on the classification. The user input is modified, based on the classification and the set of contextual information. The modified user input is passed to a virtual assistant.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates a high-level diagram of an example computing environment for providing enhanced virtual assistant interactions, in accordance with embodiments of the present disclosure.

FIG. 2 illustrates a flowchart of a method for providing modified user inputs to a virtual assistant, in accordance with embodiments of the present disclosure.

FIG. 3 illustrates a flowchart of a method for enhancing virtual assistant interactions, in accordance with embodiments of the present disclosure.

FIG. 4 illustrates an example neural network that may be used to classify and/or modify user inputs, in accordance with embodiments of the present disclosure.

FIG. 5 depicts a cloud computing environment according to an embodiment of the present disclosure.

FIG. 6 depicts abstraction model layers according to an embodiment of the present disclosure.

FIG. 7 depicts a high-level block diagram of an example computer system that may be used in implementing embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of virtual assistants, and more particularly to enhancing virtual assistant interactions. While the present disclosure is not necessarily limited to such applications, various aspects of the disclosure may be appreciated through a discussion of various examples using this context.

Virtual assistants may include conversational, computer-generated characters to simulate a conversation for the purpose of delivering audio or textual information to a user. A large portion of virtual assistants is developed for end-users, either commercially (e.g., a home assistant) or within an enterprise (e.g., a help desk or IT support chatbot). Such virtual assistants provide end-users with the ability to make queries and receive pertinent information and/or services (e.g., receive answers to questions, troubleshoot technical issues, play music, start a video, call another user, etc.). Virtual assistants can provide consistency in the quality of services/information provided, as well as increase the number of queries an IT department or other services provider can handle within a given time frame.

Embodiments of the present disclosure may provide for an enhanced interaction between end-users and virtual assistants. For example, a given percentage of user inputs (e.g., utterances, textual queries, etc.) may not be properly processed or “understood” by the virtual assistant. This may, in turn, result in low end-user adoption of the virtual assistants' services, additional costs (both in time and resources) due to ineffective API (application programming interface) calls, and potential escalation of a query/request to include a more limited resource (e.g., human service provider or technical expert).

More traditional processes for virtual assistant interactions process every utterance or input from an end-user, regardless of content. This results in a 1:1 match of input to API call. In cases where the input is insufficient (e.g., lacks proper context, input is worded incorrectly, input was not a query for the virtual assistant, input is so broad as to be “misunderstood,” etc.), a large number of ineffective/unnecessary API calls may be performed. Over time, this may increase infrastructure costs for the providers of the virtual assistants and may result in poor performance or end-user dissatisfaction. In scenarios where a plethora of users are interacting with a limited number of virtual assistants, or where the virtual assistants reside on a limited number of servers/resources, a cascade effect may overwhelm the more limited resource(s) within the process flow.

Embodiments of the present disclosure may introduce an additional component into the process flow to consolidate and/or enhance user inputs prior to an API call. For example, the additional component may be capable of classifying the input as a statement, question, or answer. Upon classification, the input may be cached and consolidated with additional inputs/utterances to create an aggregated input. Aggregated inputs may include additional information, for example, a user intent, entities involved with the input/query, other contextual information, etc.

The aggregated input may be passed to the virtual assistant for a single API call. In this way, the number of API calls may be reduced, and the quality of each API call may be increased. In this way, the interaction of the end-user with the virtual assistant may be enhanced, and resources associated with API call processing may be used more efficiently.

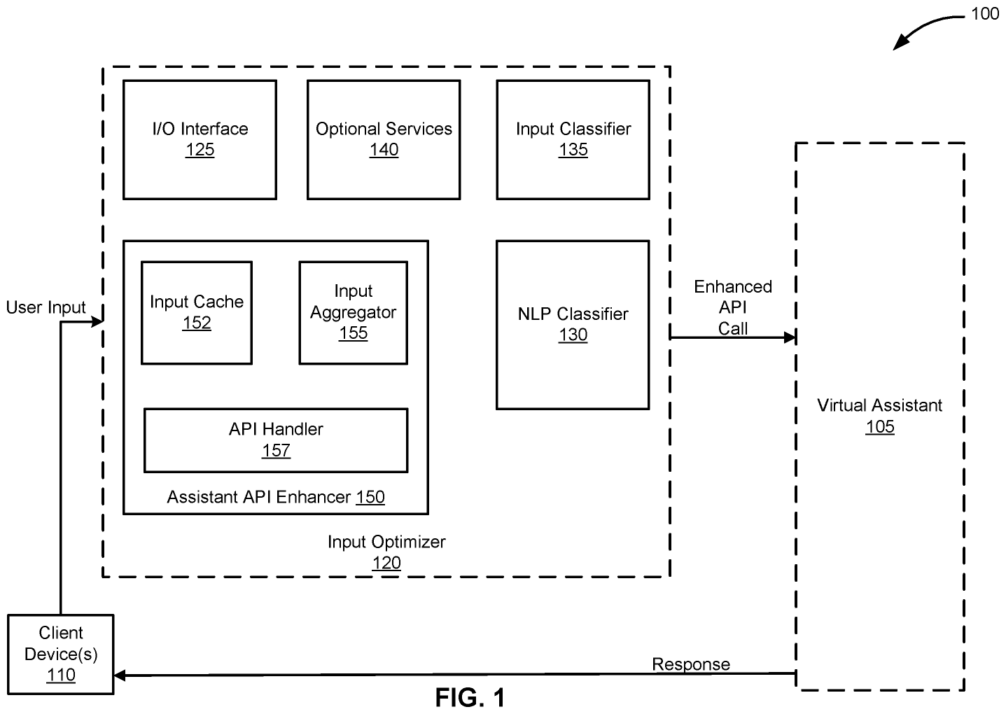

Referring now to FIG. 1, illustrated is a high-level diagram of an example computing environment for providing enhanced virtual assistant interactions, in accordance with embodiments of the present disclosure. Example computing environment 100 may be implemented as one or more physical devices (e.g., desktop computers, smart phones, tablets, etc.) communicatively coupled to each other (or even potentially a single standalone system), or it may be implemented in some degree using a cloud computing environment where one or more components of the environment are virtualized and run on a set of remote devices operating to sustain the virtualized components via one or more hypervisors. In any of these embodiments, data may be transferred using a physical or wireless network of any suitable configuration and using any suitable communications protocol(s). In some embodiments, encryption may be employed to secure the communications and maintain privacy.

In some embodiments, example computing environment 100 may include one or more client device(s) 110, a virtual assistant 105, and an input optimizer 120. In some embodiments, client device 110 may include, for example, a smartphone, tablet, desktop computer, etc. communicably coupled to virtual assistant 105 and/or input optimizer 120. In yet other embodiments, client device 110 may include a microphone or other input peripheral, and the client device 110 may be incorporated into a standalone virtual assistant device (e.g., a device including client device 110, input optimizer 120, and virtual assistant 105).

Virtual assistant 105 may include, for example, an application or service running on client device 110, an application or service running on a remote server (not pictured) communicably coupled to client device 110, or in any other suitable configuration (e.g., a standalone device, an application or service running within a cloud computing environment, etc.).

In some embodiments, input optimizer 120 may be incorporated as part of the virtual assistant 105, the client device 110, or it may be a standalone device or application/service. Input optimizer 120 may include I/O interface 125, NLP (natural language processing) classifier 130, input classifier 135, optional services 140, and assistant API enhancer 150. I/O interface 125 may include, for example, a user interface, a microphone, a keyboard, a camera, or a network adapter suitable for receiving user inputs (e.g., utterances, sign language gestures, typed input, etc.).

NLP classifier 130 may include, for example, a natural language processor for converting user inputs into machine-readable text. In some embodiments, NLP classifier 130 may further include a triplestore, text index, or relational database to enhance the contextual information of the machine-readable text output and increase the accuracy of the NLP techniques employed by the NLP classifier 130. For example, NLP classifier 130 may identify or determine the intent of a user query, an entity involved with the query (e.g., the subject of a request, the identity of the user, the identity of a person or place within the query, the service or product name, etc.), or a set of additional contextual information related to the query (e.g., to differentiate similar terms with different meanings). In some embodiments, a neural network may be implemented within the NLP classifier to employ the NLP techniques.

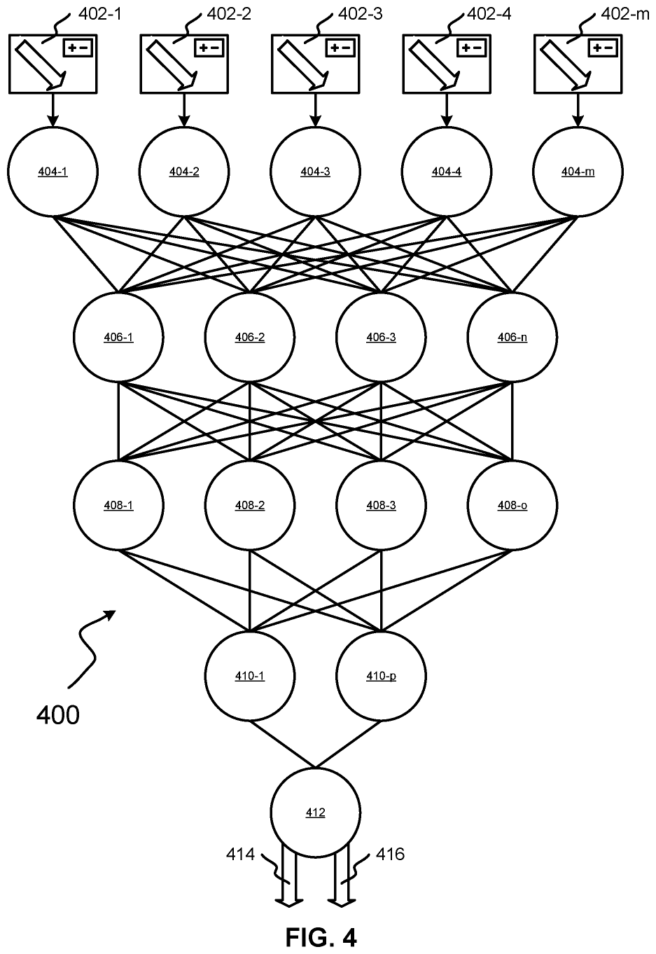

Input classifier 135 may include, for example, a neural network trained for the purpose of determining whether an input is a question, statement, or answer. Additional information regarding the operation and implementation of neural networks is included with the description of FIG. 4. In some embodiments, input classifier 135 may generate a suitable output reflecting the classifications. For example, a table of user utterances with an accompanying column for the classifications of question, statement, or answer. In some embodiments, the associated neural network may be trained with user feedback; the feedback may be used to adjust a weight and/or bias of one or more edges within the neural network.

Optional services 140 may include custom services for a particular application of the input optimizer 120. For example, optional services 140 may include language translation services, OCR (optical character recognition) services for digesting scanned documents/text, object recognition services for determining sign language communications from a video or video stream, grammar check services, etc.

In some embodiments, Assistant API enhancer 150 may receive the outputs from I/O interface 125, optional services 140, input classifier 135, and NLP classifier 130. Assistant API enhancer 150 may include, for example, input cache 152, input aggregator 155, and API handler 157. API handler 157 may be responsible for handling API calls and other API operations, such as reading API output from the NLP classifier 130. API handler 157 may further communicate with input cache 152 and input aggregator 155, and perform API calls (e.g., enhanced API calls) to the virtual assistant 105.

In some embodiments, input cache 152 may perform a user-defined threshold check (e.g., at least 1 intent, 1 entity, and 1 context) on a received input. In some embodiments, the input cache 152 may be configured to wait a given period of time to allow a user to provide more input, or the input cache may trigger a prompt to a user to provide any missing information for the threshold check (e.g., provide more context or clarify intent). Once the threshold is met, input cache 152 may trigger input aggregator 155.

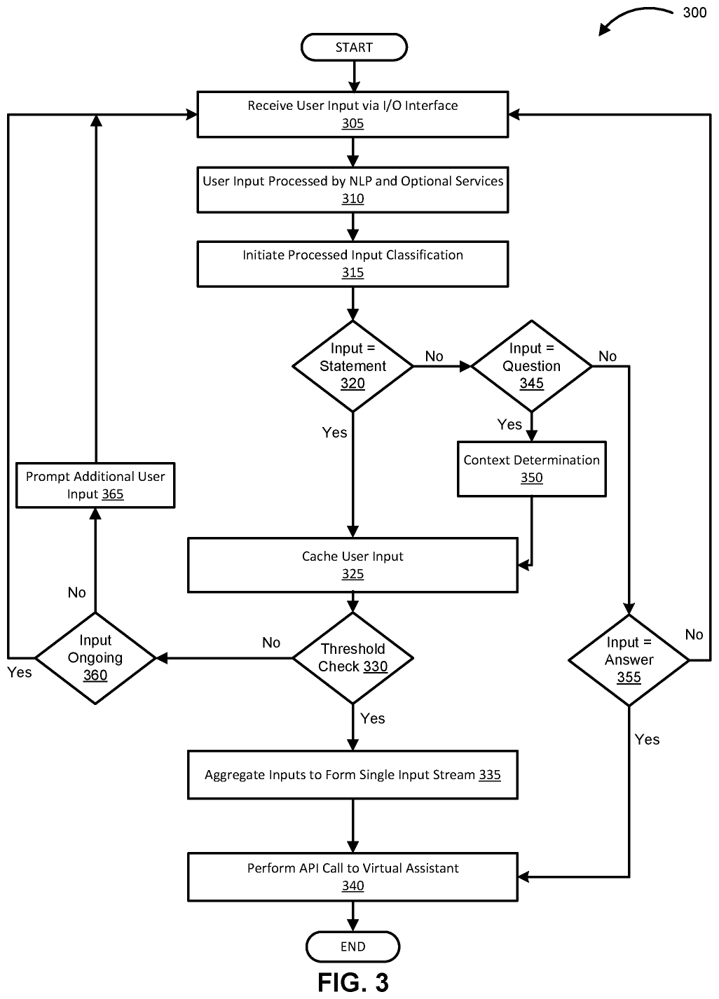

In some embodiments, input aggregator 155 may, for example, form a single input cluster (e.g., as part of an enhanced API call) and pass that cluster to the API handler 157 for communication with the virtual assistant 105. Further detail regarding data flow and processing within example computing environment 100 is described with regards to FIG. 3.

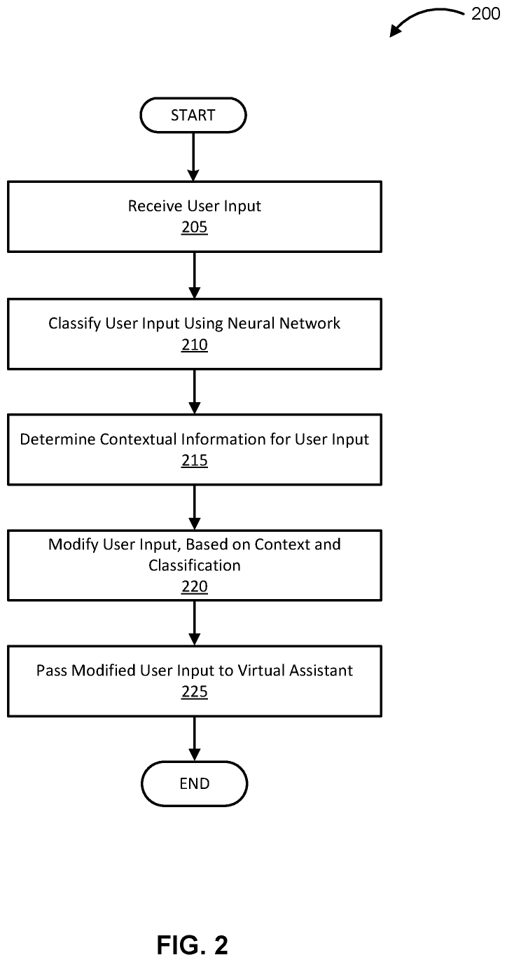

Referring now to FIG. 2, illustrated is a flowchart of a method 200 for providing modified user inputs (e.g., enhanced API calls) to a virtual assistant 105, in accordance with embodiments of the present disclosure. Method 200 may begin at 205, where a user input is received. The user input may be, for example, sign language captured by a series of still images and/or a video, textual input, audible input, or any other user input type.

At 210, the user input is classified using a neural network. For example, the user input may be classified as a statement, question, or answer, as described herein.

At 215, contextual information for the user input is determined. Contextual information may include, for example, a user intent, an entity associated with the input, and additional context (e.g., information from a relational database populated by NLP classifier 130, grammatical information, semantic information, translation information, etc.).

At 220, the user input is modified, based on the context and the classification. For example, the user input may be subjected to one or more threshold checks and, if passing the threshold, aggregated into an enhanced API call. In some embodiments, multiple inputs may be aggregated into a single enhanced API call. For example, a plurality of historical modified user inputs may be cached for later aggregation into a single enhanced API call.

At 225, the modified user input (e.g., the enhanced API call) may be passed to a virtual assistant for processing. In some embodiments, this may trigger the virtual assistant to, for example, search one or more information repositories, knowledge bases, and/or internet websites for information, begin playing music or other media content, initiate a phone or video call, communicate with an IOT device (e.g., start a microwave, preheat an oven, turn on a light, start a vehicle, etc.)

Referring now to FIG. 3, illustrated is a flowchart of a method 300 for enhancing virtual assistant interactions, in accordance with embodiments of the present disclosure. Method 300 may begin at 305, where a user input is received via an I/O interface, as described herein.

The user input may be processed, at 310, by an NLP classifier 130 and optional services 140. In some embodiments, the processing may result in a set of machine-readable text, and may include, for example, a populated relational database and/or a text translated from one language to another.

At 315, classification of the processed user input is initiated (e.g., by input classifier 135). In some embodiments, multiple processed inputs may be concurrently classified using parallelism (e.g., single instruction multiple data techniques).

At 320, it is determined whether the input is a statement (e.g., using input classifier 135). If the input is a statement, the input is cached at 325. However, if the input is not a statement, at 345, it is determined whether the input is a question.

If, at 345, the input is determined to be a question, context determination is performed at 350. Context determination may include, for example, a determination of the intent of the user input, identification of one or more entities associated with the input, or the identification/determination of additional contextual information, as described herein. The user input may then be cached at 325.

If, however, the input is not a statement or a question, it is determined whether the input is an answer at 355. An answer may be, for example, a user reply to a previous statement made by a virtual assistant. If the input is not determined to be a statement, question, or answer, the method 300 may listen for additional user input at 305. If, however, the input is determined to be an answer, the input may be passed directly to the virtual assistant via an API call at 340.

Once user inputs have been cached at 325, a threshold check is performed at 330. Threshold checks may be predetermined, or they may be determined by a user or an administrator. In some embodiments, the threshold may be dynamic (e.g., personalized, over time, to a particular user). In yet other embodiment, the threshold may be impacted by comparing a plurality of users' inputs and/or thresholds. An example of a threshold may include a requirement for a user input to contain at least 1 intent, 1 entity, and/or 1 context.

If the threshold is not met at 330, the method proceeds to 360, where a determination is made whether the input is still ongoing. For example, the user may be continuing to speak or type, and/or the user may be issuing multiple queries/inputs concurrently. If the input is determined to be ongoing, the method returns to 305 to receive the additional input. If, however, the input is not ongoing at 360, the user is prompted to provide additional information/input at 365. The method then returns to 305 to receive the additional user input(s).

If the threshold check is passed at 330, then the user input(s) are aggregated to form a single input stream at 335. In some embodiments, this may include the creation of a single enhanced API call, as described herein.

At 340, the API call is performed/sent to the virtual assistant. This may include passing a user answer directly to the virtual assistant, or it may include passing an enhanced API call to the virtual assistant, as described herein.

FIG. 4 depicts an example neural network 400 that may be used to classify, aggregate, and/or modify user inputs, in accordance with embodiments of the present disclosure. The example neural network 400 may further be communicably linked to one or more user devices, one or more virtual assistants, and/or one or more other neural networks. In embodiments, parallel techniques (e.g., Single Instruction Multiple Data (SIMD) techniques) may be employed to concurrently generate vectors from user inputs, pass modified user inputs to one or more virtual assistants, etc.

In embodiments, neural network 400 may be a classifier-type neural network. Neural network 400 may be part of a larger neural network (e.g., may be a sub-unit of a larger neural network). For example, neural network 400 may be nested within a single, larger neural network, connected to several other neural networks, or connected to several other neural networks as part of an overall aggregate neural network.

Inputs 402-1 through 402-m represent the inputs to neural network 400. In this embodiment, 402-1 through 402-m do not represent different inputs. Rather, 402-1 through 402-m represent the same input that is sent to each first-layer neuron (neurons 404-1 through 404-m) in neural network 400. In some embodiments, the number of inputs 402-1 through 402-m (i.e., the number represented by m) may equal (and thus be determined by) the number of first-layer neurons in the network. In other embodiments, neural network 400 may incorporate 1 or more bias neurons in the first layer, in which case the number of inputs 402-1 through 402-m may equal the number of first-layer neurons in the network minus the number of first-layer bias neurons. In some embodiments, a single input (e.g., input 402-1) may be input into the neural network. In such an embodiment, the first layer of the neural network may comprise a single neuron, which may propagate the input to the second layer of neurons.

Inputs 402-1 through 402-m may comprise one or more samples of classifiable data. For example, inputs 402-1 through 402-m may comprise 10 samples of classifiable data. In other embodiments, not all samples of classifiable data may be input into neural network 400.

Neural network 400 may comprise 5 layers of neurons (referred to as layers 404, 406, 408, 410, and 412, respectively corresponding to illustrated nodes 404-1 to 404-m, nodes 406-1 to 406-n, nodes 408-1 to 408-o, nodes 410-1 to 410-p, and node 412). In some embodiments, neural network 400 may have more than 5 layers or fewer than 5 layers. These 5 layers may each be comprised of the same number of neurons as any other layer, more neurons than any other layer, fewer neurons than any other layer, or more neurons than some layers and fewer neurons than other layers. In this embodiment, layer 412 is treated as the output layer. Layer 412 outputs a probability that a target event will occur and contains only one neuron (neuron 412). In other embodiments, layer 412 may contain more than 1 neuron. In this illustration no bias neurons are shown in neural network 400. However, in some embodiments each layer in neural network 400 may contain one or more bias neurons.

Layers 404-412 may each comprise an activation function. The activation function utilized may be, for example, a rectified linear unit (ReLU) function, a SoftPlus function, a Soft step function, or others. Each layer may use the same activation function, but may also transform the input or output of the layer independently of or dependent upon the activation function. For example, layer 404 may be a “dropout” layer, which may process the input of the previous layer (here, the inputs) with some neurons removed from processing. This may help to average the data and can prevent overspecialization of a neural network to one set of data or several sets of similar data. Dropout layers may also help to prepare the data for “dense” layers. Layer 406, for example, may be a dense layer. In this example, the dense layer may process and reduce the dimensions of the feature vector (e.g., the vector portion of inputs 402-1 through 402-m) to eliminate data that is not contributing to the prediction. As a further example, layer 408 may be a “batch normalization” layer. Batch normalization may be used to normalize the outputs of the batch-normalization layer to accelerate learning in the neural network. Layer 410 may be any of a dropout, hidden, or batch-normalization layer. Note that these layers are examples. In other embodiments, any of layers 404 through 410 may be any of dropout, hidden, or batch-normalization layers. This is also true in embodiments with more layers than are illustrated here, or fewer layers.

Layer 412 is the output layer. In this embodiment, neuron 412 produces outputs 414 and 416. Outputs 414 and 416 represent complementary probabilities that a target event will or will not occur. For example, output 414 may represent the probability that a target event will occur, and output 416 may represent the probability that a target event will not occur. In some embodiments, outputs 414 and 416 may each be between 0.0 and 1.0, and may add up to 1.0. In such embodiments, a probability of 1.0 may represent a projected absolute certainty (e.g., if output 414 were 1.0, the projected chance that the target event would occur would be 100%, whereas if output 416 were 1.0, the projected chance that the target event would not occur would be 100%).

In embodiments, FIG. 4 illustrates an example probability-generator neural network with one pattern-recognizer pathway (e.g., a pathway of neurons that processes one set of inputs and analyzes those inputs based on recognized patterns, and produces one set of outputs). However, some embodiments may incorporate a probability-generator neural network that may comprise multiple pattern-recognizer pathways and multiple sets of inputs. In some of these embodiments, the multiple pattern-recognizer pathways may be separate throughout the first several layers of neurons, but may merge with another pattern-recognizer pathway after several layers. In such embodiments, the multiple inputs may merge as well. This merger may increase the ability to identify correlations in the patterns identified among different inputs, as well as eliminate data that does not appear to be relevant.

In embodiments, neural network 400 may be trained/adjusted (e.g., biases and weights among nodes may be calibrated) by inputting feedback and/or input from a to correct/force the neural network to arrive at an expected output. In some embodiments, the feedback may be forced selectively to particular nodes and/or sub-units of the neural network. In some embodiments, the impact of the feedback on the weights and biases may lessen over time, in order to correct for inconsistencies among user(s) and/or datasets. In embodiments, the degradation of the impact may be implemented using a half-life (e.g., the impact degrades by 50% for every time interval of X that has passed) or similar model (e.g., a quarter-life, three-quarter-life, etc.).

It is to be understood that although this disclosure includes a detailed description on cloud computing, implementation of the teachings recited herein are not limited to a cloud computing environment. Rather, some embodiments of the present invention are capable of being implemented in conjunction with any other type of computing environment now known or later developed.

Cloud computing is a model of service deliver for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources, but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure, but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities, but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

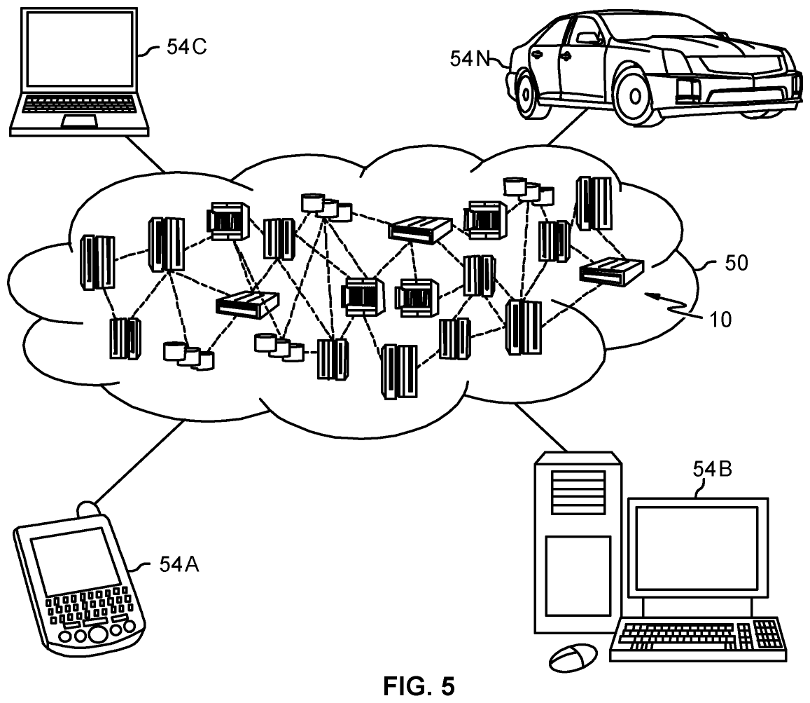

Referring now to FIG. 5, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

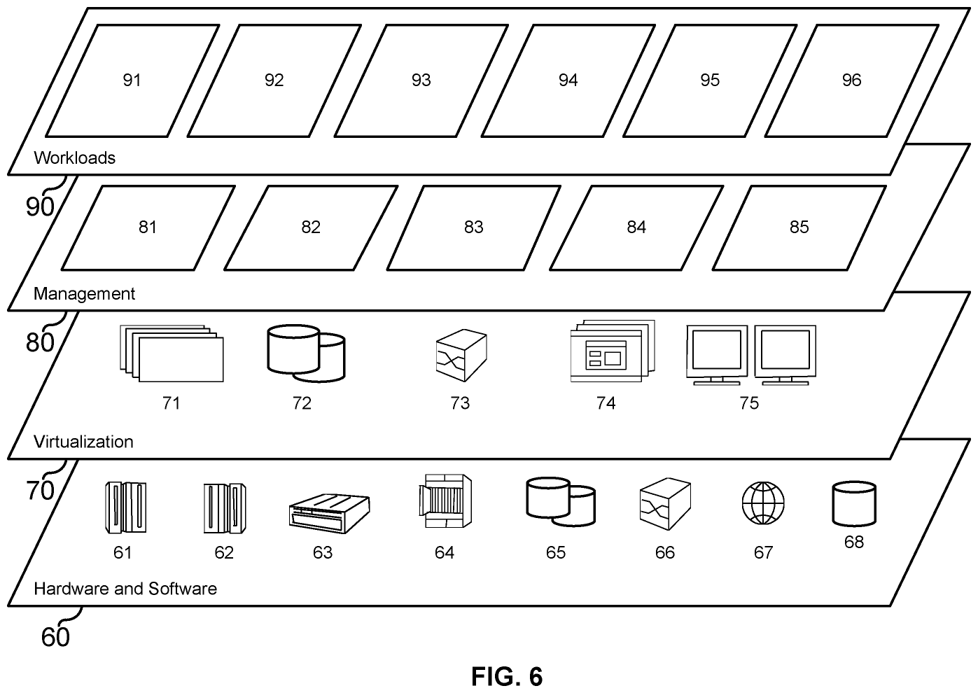

Referring now to FIG. 6, a set of functional abstraction layers provided by cloud computing environment 50 (FIG. 5) is shown. It should be understood in advance that the components, layers, and functions shown in FIG. 6 are intended to be illustrative only and some embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and enhancing virtual assistant interactions 96.

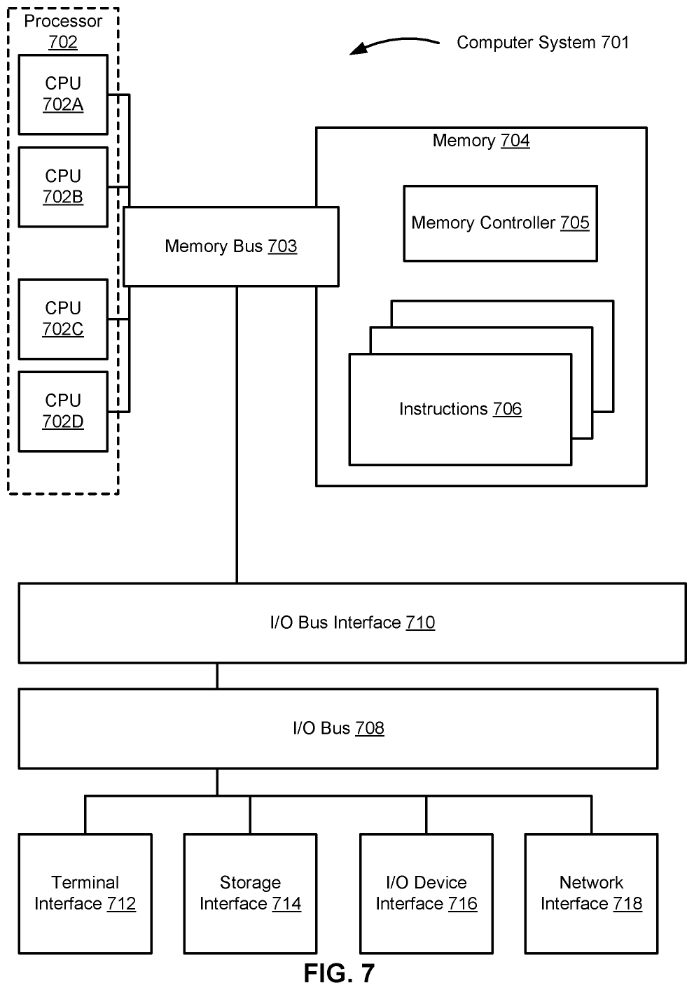

Referring now to FIG. 7, shown is a high-level block diagram of an example computer system 701 that may be configured to perform various aspects of the present disclosure, including, for example, methods 200/300, described in FIGS. 2-3. The example computer system 701 may be used in implementing one or more of the methods or modules, and any related functions or operations, described herein (e.g., using one or more processor circuits or computer processors of the computer), in accordance with embodiments of the present disclosure. In some embodiments, the illustrative components of the computer system 701 comprise one or more CPUs 702, a memory subsystem 704, a terminal interface 712, a storage interface 714, an I/O (Input/Output) device interface 716, and a network interface 718, all of which may be communicatively coupled, directly or indirectly, for inter-component communication via a memory bus 703, an I/O bus 708, and an I/O bus interface unit 710.

The computer system 701 may contain one or more general-purpose programmable central processing units (CPUs) 702A, 702B, 702C, and 702D, herein generically referred to as the CPU 702. In some embodiments, the computer system 701 may contain multiple processors typical of a relatively large system; however, in other embodiments the computer system 701 may alternatively be a single CPU system. Each CPU 702 may execute instructions stored in the memory subsystem 704 and may comprise one or more levels of on-board cache. Memory subsystem 704 may include instructions 706 which, when executed by processor 702, cause processor 702 to perform some or all of the functionality described above with respect to FIGS. 1-3.

In some embodiments, the memory subsystem 704 may comprise a random-access semiconductor memory, storage device, or storage medium (either volatile or non-volatile) for storing data and programs. In some embodiments, the memory subsystem 704 may represent the entire virtual memory of the computer system 701, and may also include the virtual memory of other computer systems coupled to the computer system 701 or connected via a network. The memory subsystem 704 may be conceptually a single monolithic entity, but, in some embodiments, the memory subsystem 704 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures. In some embodiments, the main memory or memory subsystem 704 may contain elements for control and flow of memory used by the CPU 702. This may include a memory controller 705.

Although the memory bus 703 is shown in FIG. 7 as a single bus structure providing a direct communication path among the CPUs 702, the memory subsystem 704, and the I/O bus interface 710, the memory bus 703 may, in some embodiments, comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 710 and the I/O bus 708 are shown as single respective units, the computer system 701 may, in some embodiments, contain multiple I/O bus interface units 710, multiple I/O buses 708, or both. Further, while multiple I/O interface units are shown, which separate the I/O bus 708 from various communications paths running to the various I/O devices, in other embodiments some or all of the I/O devices may be connected directly to one or more system I/O buses.

In some embodiments, the computer system 701 may be a multi-user mainframe computer system, a single-user system, or a server computer or similar device that has little or no direct user interface, but receives requests from other computer systems (clients). Further, in some embodiments, the computer system 701 may be implemented as a desktop computer, portable computer, laptop or notebook computer, tablet computer, pocket computer, telephone, smart phone, mobile device, or any other appropriate type of electronic device.

It is noted that FIG. 7 is intended to depict the representative example components of an exemplary computer system 701. In some embodiments, however, individual components may have greater or lesser complexity than as represented in FIG. 7, components other than or in addition to those shown in FIG. 7 may be present, and the number, type, and configuration of such components may vary.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for enhancing virtual assistant interactions, the method comprising:
receiving a user input;
classifying, using a neural network, the user input;
determining, based on the classification, a set of contextual information for the user input;
modifying the user input, based on the classification and the set of contextual information;
aggregating the modified user input with a plurality of historical modified user inputs wherein the historical modified user inputs are user inputs from prior inputs;
generating an aggregate modified user input, based on the classification, the set of contextual information, and the aggregated plurality of historical modified user inputs; and
passing the aggregated modified user input to a virtual assistant.

2. The method of claim 1, wherein the neural network is a classifier neural network, and wherein the user input is classified as a question, a statement, or an answer.

3. The method of claim 1, wherein the set of contextual information includes an intent, an entity, and a context.

4. (canceled)

5. The method of claim 1, further comprising:
receiving, from the virtual assistant, a response to the user input; and
notifying the user of the response.

6. The method of claim 5, wherein modifying the user input is predicated upon the set of contextual information meeting a context threshold.

7. The method of claim 5, wherein the classified user input is cached and aggregated with a plurality of classified user inputs, and wherein passing the modified user input is predicated upon the modified user input meeting a context threshold.

8. The method of claim 5, wherein the neural network is trained prior to receiving the user input and wherein the training includes adjusting a weight or a bias of the neural network.

9. A computer program product for enhancing virtual assistant interactions, the computer program product comprising a computer readable storage medium having program instructions embodied therewith, the program instructions executable by a device to cause the device to:
receive a user input;
classify, using a neural network, the user input;
determine, based on the classification, a set of contextual information for the user input;
modify the user input, based on the classification and the set of contextual information;
aggregate the modified user input with a plurality of historical modified user inputs;
generate an aggregate modified user input, based on the classification, the set of contextual information, and the aggregated plurality of historical modified user inputs; and
pass the aggregated modified user input to a virtual assistant.

10. The computer program product of claim 9, wherein the neural network is a classifier neural network, and wherein the user input is classified as a question, a statement, or an answer.

11. The computer program product of claim 9, wherein the set of contextual information includes an intent, an entity, and a context.

12. (canceled)

13. The computer program product of claim 9, wherein the program instructions further cause the device to:
receive, from the virtual assistant, a response to the user input; and
notify the user of the response.

14. The computer program product of claim 13, wherein modifying the user input is predicated upon the set of contextual information meeting a context threshold.

15. The computer program product of claim 13, wherein the classified user input is cached and aggregated with a plurality of classified user inputs, and wherein passing the modified user input is predicated upon the modified user input meeting a context threshold.

16. A system for enhancing virtual assistant interactions, comprising:
a memory with program instructions included thereon; and
a processor in communication with the memory, wherein the program instructions cause the processor to:
receive a user input;
classify, using a neural network, the user input;
determine, based on the classification, a set of contextual information for the user input;
modify the user input, based on the classification and the set of contextual information;
aggregate the modified user input with a plurality of historical modified user inputs;
generate an aggregate modified user input, based on the classification, the set of contextual information, and the aggregated plurality of historical modified user inputs; and
pass the aggregated modified user input to a virtual assistant.

17. The system of claim 16, wherein the neural network is a classifier neural network, and wherein the user input is classified as a question, a statement, or an answer.

18. The system of claim 16, wherein the set of contextual information includes an intent, an entity, and a context.

19. (canceled)

20. The system of claim 16, wherein the program instructions further cause the processor to:
receive, from the virtual assistant, a response to the user input; and
notify the user of the response.
